(19) United States
(12) Patent Application Publication
(10) Pub. No.: US 2025/0363069 A1
(43) Pub. Date: Nov. 27, 2025

(54) USB CIRCUIT AND OPERATING METHOD THEREOF AND USB DEVICE

(71) Applicant: ASMedia Technology Inc., New Taipei City (TW)

(72) Inventors: Te-Ming Kung, New Taipei City (TW); Kuo Lung Li, New Taipei City (TW); Wei-Kao Chang, New Taipei City (TW)

(73) Assignee: ASMedia Technology Inc., New Taipei City (TW)

(21) Appl. No.: 18/768,001

(22) Filed: Jul. 10, 2024

(30) Foreign Application Priority Data
May 27, 2024 (TW) 113119466

(51) Int. Cl. G06F 13/42

(52) U.S. Cl. CPC G06F 13/4282; G06F 2213/0042

(57) ABSTRACT

A USB circuit and an operating method thereof, and a USB device are provided. The USB circuit includes an upstream port interface circuit, a routing circuit, a first mode integrating circuit, a second mode integrating circuit, a downstream port interface circuit, and a controlling circuit. The upstream port interface circuit is connected to a USB host. The routing circuit is connected to the upstream port interface circuit. The downstream port interface circuit is connected to at least one of the first mode integrating circuit and the second mode integrating circuit. The controlling circuit is connected to the routing circuit. The controlling circuit determines whether to connect the routing circuit with the first mode integrating circuit or the second mode integrating circuit according to a connection state between the USB circuit and the USB host, thereby dynamically switching an operating mode between the USB circuit and the USB host.

### CROSS-REFERENCE TO RELATED APPLICATION

This application claims the priority benefit of Taiwan application serial no. 113119466, filed on May 27, 2024. The entirety of the above-mentioned patent application is hereby incorporated by reference herein and made a part of this specification.

### BACKGROUND

### Technical Field

The disclosure relates to an electronic circuit, and more particularly, to a USB circuit using universal serial bus (hereinafter referred to as USB) and an operating method thereof, and a USB device.

### Description of Related Art

Generally speaking, hosts using a USB4 specification include a connection manager (CM). The USB4 host enumerates, configures, and manages a USB4 device connected to the USB4 host through the connection manager. Since different connection managers correspond to different versions, and the specification applied by the USB4 device develops rapidly, the USB4 host and the USB4 device often experience incompatibility or failure to connect successfully.

However, in order to solve the above issues, the current USB4 host may only continuously re-establish connections with the USB4 device, or output billboard device information to prompt users. In this case, the users need to update the version of the connection manager of the USB4 host by themselves.

### SUMMARY

The disclosure provides a USB circuit, which may dynamically switch an operating mode between the USB circuit and a USB host, thereby automatically eliminating abnormal conditions of incompatibility with the USB host or connections that may not be successful.

A USB circuit in the embodiment of the disclosure includes an upstream port interface circuit, a routing circuit, a first mode integrating circuit, a second mode integrating circuit, a downstream port interface circuit, and a controlling circuit. The upstream port interface circuit is configured to be connected to a USB host. The routing circuit is connected to the upstream port interface circuit. The downstream port interface circuit is connected to at least one of the first mode integrating circuit and the second mode integrating circuit, and is configured to be connected to at least one output device. The controlling circuit is connected to the routing circuit. The controlling circuit is configured to determine whether to connect the routing circuit to the first mode integrating circuit or the second mode integrating circuit according to a connection state between the USB circuit and the USB host.

An embodiment of the disclosure further provides an operating method of a USB circuit. The operating method includes the following. A USB host is connected through an upstream port interface circuit of the USB circuit. The upstream port interface circuit is further connected to a routing circuit of the USB circuit. The USB circuit further includes a downstream port interface circuit, a first mode integrating circuit, and a second mode integrating circuit. Through a controlling circuit of the USB circuit, it is determined whether to connect the routing circuit to the first mode integrating circuit or the second mode integrating circuit according to a connection state between the USB circuit and the USB host.

An embodiment of the disclosure further provides a USB device. The USB device includes at least one upstream connection port, at least downstream connection port, and a USB circuit. The USB circuit includes an upstream port interface circuit, a routing circuit, a first mode integrating circuit, a second mode integrating circuit, a downstream port interface circuit, and a controlling circuit. The upstream port interface circuit is configured to be connected to a USB host through the upstream connection port. The routing circuit is connected to the upstream port interface circuit. The downstream port interface circuit is connected to at least one of the first mode integrating circuit and the second mode integrating circuit, and is configured to be connected to at least one output device through the downstream connection port. The controlling circuit is connected to the routing circuit. The controlling circuit is configured to determine whether to connect the routing circuit to the first mode integrating circuit or the second mode integrating circuit according to a connection state between the USB circuit and the USB host.

Based on the above, in the USB circuit and the operating method thereof, and the USB device according to the embodiments of the disclosure, the controlling circuit connects the routing circuit and the target mode integrating circuit according to the connection state between the USB circuit and the USB host, and may dynamically switch between different operating modes corresponding to the mode integrating circuits. In this way, the USB circuit may be automatically connected to the USB host to eliminate connection abnormality.

In order for the aforementioned features and advantages of the disclosure to be more comprehensible, embodiments accompanied with drawings are described in detail below.

### BRIEF DESCRIPTION OF THE DRAWINGS

FIG. 1 is a circuit block diagram of a USB device and a USB circuit according to an embodiment of the disclosure.

FIG. 2 is a flowchart of an operating method of a USB circuit according to an embodiment of the disclosure.

FIG. 3 is a circuit block diagram of a USB host according to an embodiment of the disclosure.

FIG. 4 is a circuit block diagram of a USB device and a USB circuit according to another embodiment of the disclosure.

FIG. 5 is a circuit block diagram of a PCIe tunnel router according to the embodiment of FIG. 4 of the disclosure.

FIGS. 6A to 6B are flowcharts of an operating method of a USB circuit according to the embodiment of FIG. 4 of the disclosure.

FIG. 7 is a circuit block diagram of a USB device and a USB circuit according to another embodiment of the disclosure.

FIG. 8 is a circuit block diagram of a USB device and a USB circuit according to another embodiment of the disclosure.

FIG. 9 is a circuit block diagram of a USB device and a USB circuit according to another embodiment of the disclosure.

### DETAILED DESCRIPTION OF DISCLOSED EMBODIMENTS

Some embodiments of the disclosure will be described in detail with reference to the accompanying drawings. For reference numerals cited in the following descriptions, the same reference numerals appearing in different drawings are regarded as the same or similar components. The embodiments are only a part of the disclosure and do not disclose all possible implementations of the disclosure. More precisely, the embodiments are merely examples of the device and the method.

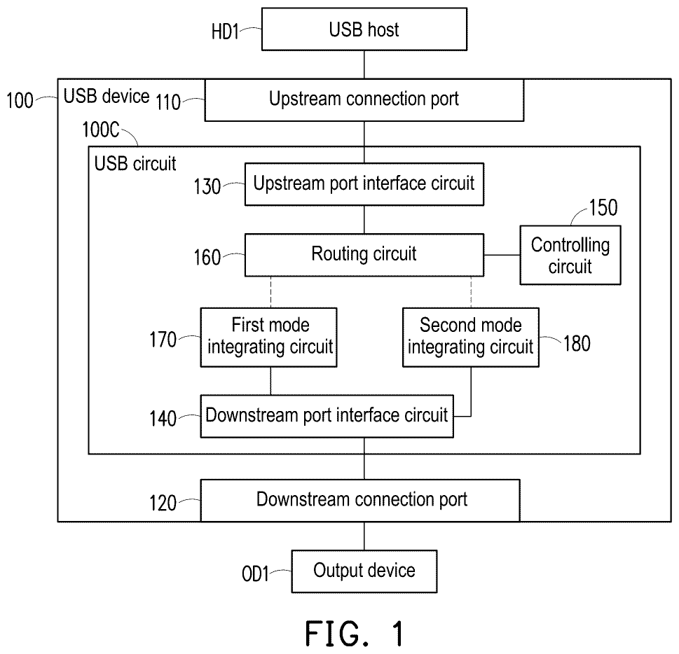

FIG. 1 is a circuit block diagram of a USB device and a USB circuit according to an embodiment of the disclosure. Referring to FIG. 1, a USB device 100 may be, for example, an electronic device using a USB4 specification. The USB device 100 is configured to be connected to a USB host HD1. The USB host HD1 is a host using the USB4 specification and includes any version of a connection manager (not shown). The USB device 100 is further configured to be connected to an output device OD1. The output device OD1 may be, for example, a display, an external hard disk, and electronic devices such as various communication interface devices. In some applications, the USB device 100 is not connected to the output device OD1.

In the embodiment of FIG. 1, the USB device 100 includes at least one upstream connection port 110, at least one downstream connection port 120, and a USB circuit 100C. The USB circuit 100C may be, for example, a USB integrated circuit. The USB circuit 100C includes an upstream port interface circuit 130, a downstream port interface circuit 140, a controlling circuit 150, a routing circuit 160, a first mode integrating circuit 170 and a second mode integrating circuit 180.

In this embodiment, the upstream port interface circuit 130 is configured to be connected to the USB host HD1 through the upstream connection port 110. The upstream port interface circuit 130 and the upstream connection port 110 may be, for example, an upstream-facing port (UFP) circuit in the USB device 100.

In this embodiment, the downstream port interface circuit 140 is configured to be connected to the output device OD1 through the downstream connection port 120. The downstream port interface circuit 140 and the downstream connection port 120 may be, for example, a downstream-facing port (DFP) circuit in the USB device 100. The downstream port interface circuit 140 is further connected to at least one of the first mode integrating circuit 170 and the second mode integrating circuit 180.

In this embodiment, the first mode integrating circuit 170 corresponds to a first mode of the USB circuit 100C. The first mode may, for example, be an operating mode that complies with the USB4 specification. The second mode integrating circuit 180 corresponds to a second mode of the USB circuit 100C. The second mode may be, for example, an operating mode that complies with conventional USB specifications (e.g., USB3 and/or USB2 specifications).

In this embodiment, the routing circuit 160 is connected to the upstream port interface circuit 130 and the controlling circuit 150. The routing circuit 160 is controlled by the controlling circuit 150 to switch between connections to the first mode integrating circuit 170 and the second mode integrating circuit 180.

In this embodiment, the controlling circuit 150 may be, for example, a signal converter, a field programmable gate array (FPGA), a central processing unit (CPU), or other programmable general-purpose or special-purpose microprocessors, a digital signal processor (DSP), a programmable controller, an application specific integrated circuit (ASIC), a programmable logic device (PLD), other similar devices or a combination of these devices, which may load and execute relevant firmware or software to achieve control and computing functions.

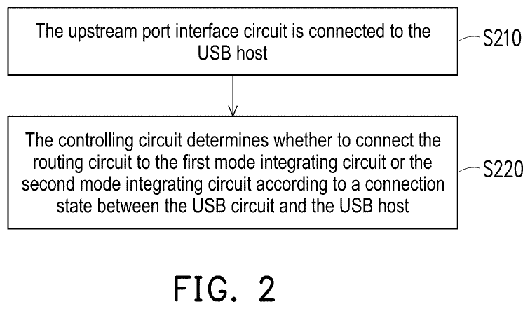

FIG. 2 is a flowchart of an operating method of a USB circuit according to an embodiment of the disclosure. Referring to FIGS. 1 and 2, the USB circuit 100C may execute steps S210 to S220. An order of the steps S210 to S220 is only an example for description, and is not limited thereto.

In step S210, the upstream port interface circuit 130 is connected to the USB host HD1 through the upstream connection port 110.

In step S220, the controlling circuit 150 determines whether to connect the routing circuit 160 to the first mode integrating circuit 170 or the second mode integrating circuit 180 according to a connection state between the USB circuit 100C and the USB host HD1. The connection state indicates a result of an agreement of an operating mode between the USB circuit 100C and the USB host HD1. The connection state may, for example, indicate a failure of an operation in the first mode, or indicate a failure of an operation in the second mode.

It is worth mentioning that by the controlling circuit 150 choosing to connect the routing circuit 160 to the first mode integrating circuit 170 or the second mode integrating circuit 180 according to the connection state between the USB circuit 100C and the USB host HD1, the USB circuit 100C may be dynamically switched between first mode and second mode. In this way, even if the connection manager in the USB host HD1 is incompatible with the USB device 100 or may not be connected successfully, the USB device 100 may change the operating mode through the USB circuit 100C, and then be connected to the USB host HD1 in an appropriate operating mode, thereby automatically eliminating connection abnormality without user intervention.

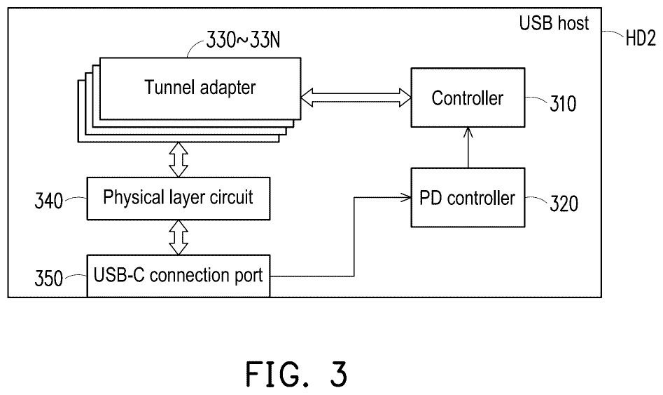

FIG. 3 is a circuit block diagram of a USB host according to an embodiment of the disclosure. Referring to FIG. 3, a USB host HD2 may be, for example, an implementation of the USB host HD1 in FIG. 1. The USB host HD2 includes a controller 310, a power delivery (PD) controller 320, multiple tunnel adapters 330 to 33N, a physical layer circuit 340, and a connection port 350, where N is a positive integer greater than 1.

In this embodiment, the connection port 350 is connected to the physical layer circuit 340 and the PD controller 320. The connection port 350 may be, for example, a connection port using USB type-C (hereinafter referred to as USB-C). The connection port 350 is configured to be connected to a USB device (e.g., the USB device 100 in FIG. 1).

In this embodiment, the PD controller 320 is connected to controller 310. The PD controller 320 performs a communication operation with the connected USB device through the connection port 350 to agree on operating modes such as power transmission and data transmission therebetween. The PD controller 320 transmits a result of the communication operation to controller 310.

In this embodiment, the controller 310 is connected to the tunnel adapters 330 to 33N. The controller 310 selects one of the tunnel adapters 330 to 33N according to the result of the communication operation to transmit data to the connected USB device through the tunnel adapter, the physical layer circuit 340, and the connection port 350.

In this embodiment, the physical layer circuit 340 and the tunnel adapters 330 to 33N respectively comply with the USB4 specification. The tunnel adapters 330 to 33N correspond to different tunnel protocols respectively to process and transmit the data based on the corresponding tunnel protocols.

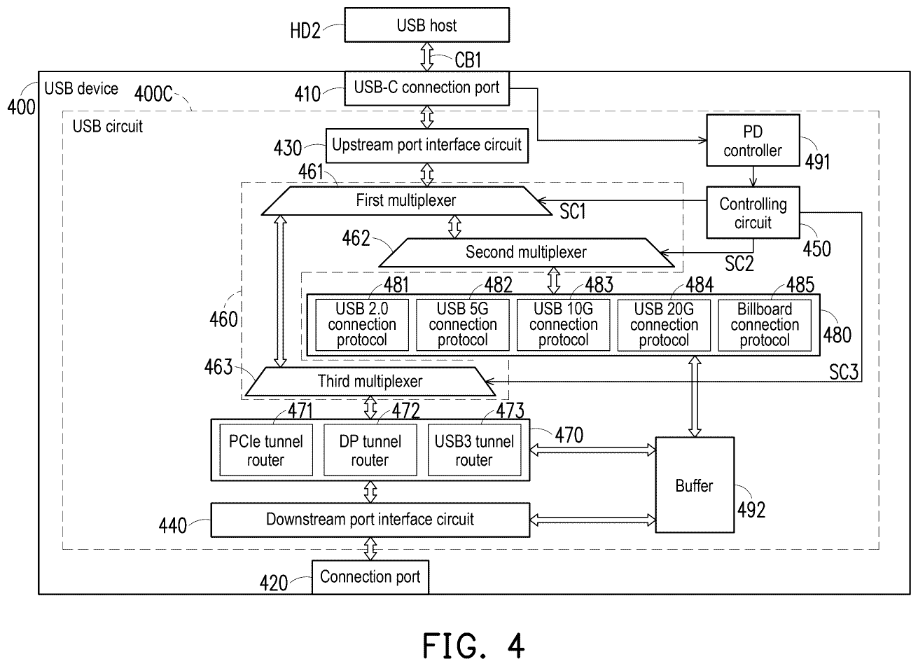

FIG. 4 is a circuit block diagram of a USB device and a USB circuit according to another embodiment of the disclosure. Referring to FIG. 4, a USB device 400 is configured to be connected to the USB host HD2. The USB device 400 includes at least one upstream connection port 410, at least one downstream connection port 420, and a USB circuit 400C. The USB circuit 400C includes an upstream port interface circuit 430, a downstream port interface circuit 440, a controlling circuit 450, a routing circuit 460, a first mode integrating circuit 470, and a second mode integrating circuit 480. The USB device 400 and the USB circuit 400C may refer to relevant descriptions of the USB device 100 and the USB circuit 100C, and may be derived by analogy.

In the embodiment of FIG. 4, the upstream connection port 410 may be, for example, a connection port using USB-C. The upstream connection port 410 is configured to be connected to a corresponding connection port (e.g., the connection port 350 in FIG. 3) in the USB host HD2 through a USB-C cable CB1. The downstream connection port 420 may be, for example, a connection port using USB-C, USB Type-A, a display port (DP), a high definition multimedia interface (HDMI), or other transmission standards.

In this embodiment, the first mode integrating circuit 470 includes multiple tunnel routers 471 to 473. The tunnel routers 471 to 473 comply with the USB4 specification and correspond to different tunnel protocols respectively. In detail, the tunnel router 471 may be, for example, a tunnel router that complies with a PCI express (PCIe) specification (hereinafter referred to as the PCIe tunnel router 471). The tunnel router 472 may be, for example, a DP tunnel router that complies with a display port (DP) specification (hereinafter referred to as the DP tunnel router 472). The tunnel router 473 may be, for example, a USB3 tunnel router that complies with the USB4 specification (i.e., USB3 tunneling).

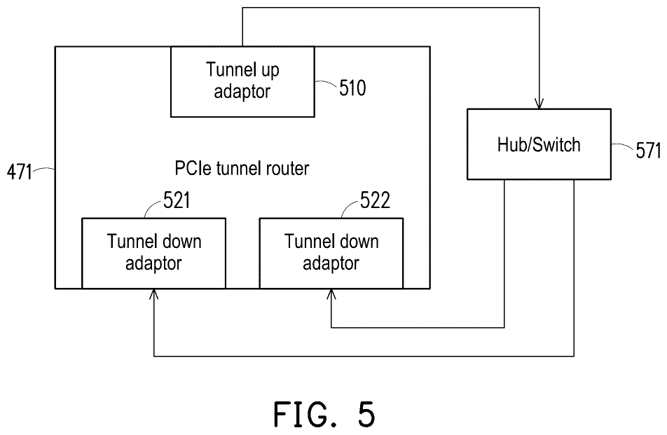

Referring to FIG. 5 together, FIG. 5 is a circuit block diagram of a PCIe tunnel router according to the embodiment of FIG. 4 of the disclosure. The PCIe tunnel router 471 includes at least one tunnel up adapter 510 and multiple tunnel down adapters 521 to 522. The number of tunnel down adapters 521 to 522 is only an example for description.

In this embodiment, the tunnel up adapter 510 is connected to a hub (or switch) 571 of the first mode integrating circuit 470 and the tunnel down adapters 521 to 522. The tunnel up adapter 510 packages original data (e.g., PCIe data) from the USB host HD2 into tunnel data that complies with the USB4 specification.

In this embodiment, the tunnel down adapters 521 to 522 are respectively connected to the hub (or switch) 571. Each of the tunnel down adapters 521 to 522 restores the tunnel data that complies with the USB4 specification to the original data (e.g., the PCIe data). In this embodiment, the DP tunnel router 472 and the USB3 tunnel router 473 may refer to relevant descriptions of the PCIe tunnel router 471, and may be derived by analogy.

Returning to FIG. 4, the second mode integrating circuit 480 has multiple connection protocols 481 to 485. The connection protocols 481 to 485 comply with specifications of a legacy mode (e.g., the USB2 specification), and correspond to different transmission speeds respectively. In detail, the connection protocol 481 indicates a USB 2.0 connection protocol. The connection protocol 482 indicates a USB 5G connection protocol. The connection protocol 483 indicates a USB 10G connection protocol. The connection protocol 484 indicates a USB 20G connection protocol. The connection protocol 485 indicates a billboard device connection protocol. In the legacy mode, according to the transmission speeds of the data transmission from fast to slow, an order of the connection protocols 481 to 485 is the connection protocol 484, the connection protocol 483, the connection protocol 482, the connection protocol 481, and the connection protocol 485.

In this embodiment, the routing circuit 460 includes a first multiplexer 461, a second multiplexer 462, and a third multiplexer 463. The first multiplexer 461 is connected to the upstream port interface circuit 430 and the controlling circuit 450. The second multiplexer 462 is connected to the controlling circuit 450 and the second mode integrating circuit 480. The second multiplexer 462 is further configured to be connected to the first multiplexer 461. The third multiplexer 463 is connected to the controlling circuit 450 and the first mode integrating circuit 470. The third multiplexer 463 is further configured to be connected to the first multiplexer 461.

Continuing with the above description, the first multiplexer 461 is controlled by the controlling circuit 450. The first multiplexer 461 chooses to be connected to the second multiplexer 462 or the third multiplexer 463 according to a first controlling signal SC1 from the controlling circuit 450. That is to say, the first multiplexer 461 switches between connections to the second multiplexer 462 and the third multiplexer 463 according to the first controlling signal SC1, so as to further switch between connections to the first mode integrating circuit 470 and the second mode integrating circuit 480. The first multiplexer 461 may also be called a protocol routing circuit.

In this embodiment, the second multiplexer 462 is controlled by the controlling circuit 450. The second multiplexer 462 selects one of multiple connection protocols to be connected to the second mode integrating circuit 480 according to a second controlling signal SC2 from the controlling circuit 450. The connection protocols respectively correspond to the connection protocols 481 to 485 in the second mode integrating circuit 480. That is to say, when the first multiplexer 461 is connected to the second multiplexer 462, the second multiplexer 462 switches between different connection protocols according to the second controlling signal SC2. The second multiplexer 462 may also be called a USB routing circuit.

In this embodiment, the third multiplexer 463 is controlled by the controlling circuit 450. The third multiplexer 463 selects one of the tunnel protocols to be connected to the first mode integrating circuit 470 according to a third controlling signal SC3 from the controlling circuit 450. The tunnel protocols respectively correspond to the tunnel protocols in the first mode integrating circuit 470, and respectively correspond to the tunnel routers 471 to 473. That is to say, when the first multiplexer 461 is connected to the third multiplexer 463, the third multiplexer 463 switches between different tunnel protocols (i.e., the different tunnel routers 471 to 473) according to the third controlling signal SC3. The third multiplexer 463 may also be called a tunnel routing circuit.

In this embodiment, the upstream port interface circuit 430 may be, for example, a first combo-physical layer circuit. The upstream port interface circuit 430 includes a corresponding physical layer circuit and a transport layer circuit (not shown). The upstream port interface circuit 430 is connected to the upstream connection port 410 and the routing circuit 460.

Specifically, a first channel end of the upstream port interface circuit 430 is connected to the first multiplexer 461. The upstream port interface circuit 430 converts a format of the data transmitted to the first multiplexer 461 into an analog format. A second channel end of the upstream port interface circuit 430 is connected to the upstream connection port 410. The upstream port interface circuit 430 processes the data transmitted through the upstream connection port 410 to complete an interface conversion operation corresponding to an upstream-facing port in the USB4 specification.

In this embodiment, the USB circuit 400C further includes a power delivery (PD) controller 491. The PD controller 491 is connected to the upstream connection port 410 and the controlling circuit 450. In some embodiments, the PD controller 491 is disposed in other circuits of the USB device 400 without being integrated in the USB circuit 400C.

In this embodiment, the USB circuit 400C further includes a buffer 492. The buffer 492 may be, for example, a data buffer. The buffer 492 is connected to the first mode integrating circuit 470, the second mode integrating circuit 480, and the downstream port interface circuit 440.

Specifically, a first channel end of the buffer 492 is connected to an output channel end of the second mode integrating circuit 480. A second channel end of the buffer 492 is connected to multiple tunnel down adapters (including the tunnel down adapters 521 to 522 in FIG. 5) of the tunnel routers 471 to 473 respectively. A third channel end of the buffer 492 is connected to a first output channel end of the downstream port interface circuit 440. The buffer 492 temporarily stores the data transmitted to any one of the tunnel routers 471 to 473, the second mode integrating circuit 480, and the downstream port interface circuit 440. The aforementioned data may be, for example, the PCIe data, DP data, data complying with USB3, or data complying with USB2. The buffer 492 preprocesses the temporarily stored data (e.g., the DP data).

In this embodiment, the downstream port interface circuit 440 may be, for example, a second combo-physical layer circuit. The downstream port interface circuit 440 includes a corresponding physical layer circuit and a transport layer circuit (not shown). The downstream port interface circuit 440 is connected to the downstream connection port 420, the routing circuit 460, and the buffer 492.

Specifically, a first channel end of the downstream port interface circuit 440 is connected to the buffer 492. The downstream port interface circuit 440 temporarily stores the data in the buffer 492. A second channel end of the downstream port interface circuit 440 is connected to multiple tunnel down adapters (including the tunnel down adapters 521 to 522 in FIG. 5) of the tunnel routers 471 to 473 respectively. A third channel end of the downstream port interface circuit 440 is connected to the downstream connection port 420. The downstream port interface circuit 440 processes the data from the tunnel routers 471 to 473 respectively to complete conversion operations of various transmission interfaces (including PCIE, DP, and USB3). In some applications, the downstream port interface circuit 440 directly transmits the respective data (e.g., the PCIe data) of the tunnel routers 471 to 473 to the corresponding downstream connection port 420 (e.g., a PCIe connection port), thereby accelerating the transmission speed of the data.

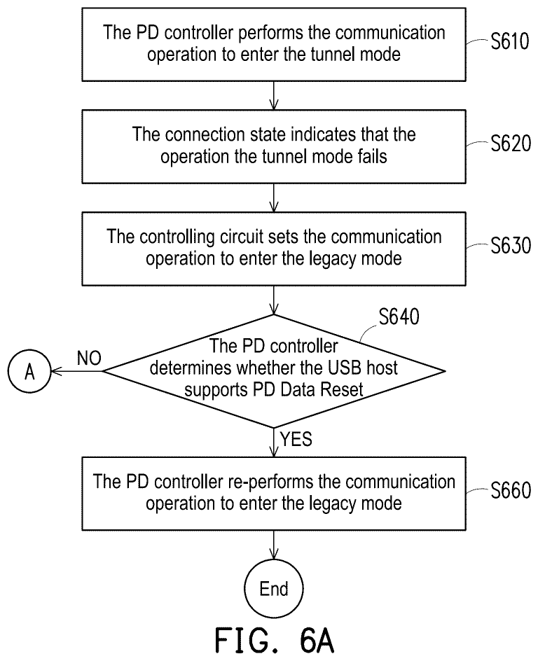

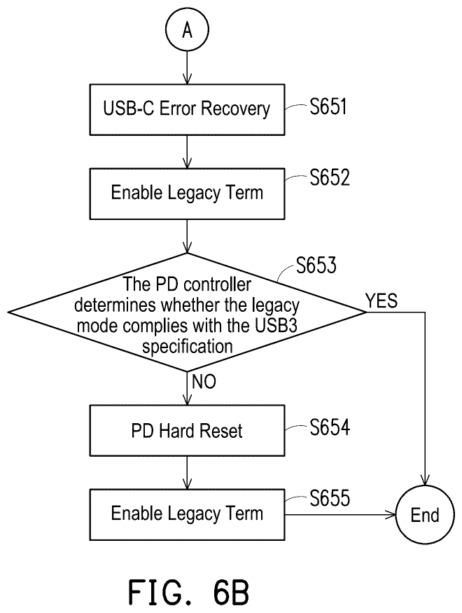

FIGS. 6A to 6B are flowcharts of an operating method of a USB circuit according to the embodiment of FIG. 4 of the disclosure. Referring to FIGS. 4 and 6A to 6B, the USB circuit 400C may execute steps S610 to S660. An order of the steps S610 to S660 is only an example for description, and is not limited thereto. In this embodiment, steps S610 to S660 may be applied to the following exemplary situations.

In this embodiment, the PD controller 491 performs the communication operation with a PD controller (e.g., the PD controller 320 in FIG. 3) in the USB host HD2 through the upstream connection port 410 to agree on the operating modes such as the power transmission and the data transmission therebetween. The PD controller 491 transmits the result of the communication operation to the controlling circuit 450.

Specifically, a set of configuration channel (CC) pins in the PD controller 491 is connected to a set of CC pins in the PD controller of the USB host HD2 through the upstream connection port 410 and the USB-C cable CB1. A CC signal is transmitted between the PD controller 491 and the PD controller of the USB host HD2. The CC signal complies with the specifications in the PD protocol and indicates various communication information between the USB device 400 and the USB host HD2. The aforementioned communication information includes a data transmission protocol, such as operating in the first mode, operating in the second mode, or a target transmission speed for operating in the second mode.

In this embodiment, the first mode is the operating mode that complies with the USB4 specification, and may be, for example, a tunnel mode. The first mode further indicates a tunnel data protocol to correspond to the different tunnel routers 471 to 473. The tunnel data protocol may be, for example, one of a PCIe tunnel protocol, a DP tunnel protocol, and a USB3 tunnel protocol.

In this embodiment, the second mode is an operating mode that complies with a legacy mode specification, and may be, for example, USB2 or USB3. The second mode further indicates a target connection protocol to correspond to the different transmission speeds. The target connection protocol may be, for example, one of the connection protocols 481 to 485.

In addition, a management controlling signals is transmitted between the PD controller 491 and the connection manager of the USB host HD2. The management controlling signal indicates setting or reporting of the data transmission protocol between the upstream connection port 410 and the USB host HD2.

In step S610, the PD controller 491 performs the communication operation with the PD controller in the USB host HD2 to enter the preset first mode (i.e., the tunnel mode). The PD controller 491 continues to perform the communication operation of the tunnel data protocol based on the tunnel mode. The PD controller 491 reports the result of the communication operation to controlling circuit 450.

At this time, the controlling circuit 450 determines a connection state between the USB circuit 400C and the USB host HD2 based on a success or failure of the communication operation. Specifically, when the communication operation is successful, the controlling circuit 450 determines that the connection state indicates that the USB circuit 400C and the USB host HD2 complete a connection of the corresponding tunnel data protocol in the tunnel mode. On the other hand, when the communication operation fails, the controlling circuit 450 determines that the connection state indicates that the USB circuit 400C and the USB host HD2 may not establish the connection of the tunnel mode.

In step S620, when the connection state indicates that the operation of the first mode (i.e., the tunnel mode) corresponding to the first mode integrating circuit 470 fails, it means that the connection of the tunnel mode may not be established between the USB circuit 400C and the USB host HD2, or the USB host HD2 does not support the tunnel mode.

In step S630, the controlling circuit 450 sets the communication operation between the PD controller 491 and the USB host HD2 to enter the second mode (i.e., the legacy mode) according to the connection state in step S620. That is to say, the controlling circuit 450 switches the routing circuit 460 from being connected to the first mode integrating circuit 470 to being connected to the second mode integrating circuit 480, thereby automatically changing from a connection configuration of the tunnel mode to a connection configuration of the legacy mode.

It should be noted that the USB circuit 400C switches between the tunnel mode and the legacy mode in a firmware-based manner according to the connection state between itself and the USB host HD1. Therefore, the USB circuit 400C is not required to change the operating modes through various adapters that execute additional settings. In this way, the USB circuit 400C may automatically and dynamically eliminate the connection abnormality in the connection between the USB device 400 and the USB host HD2.

In step S640, during a process of re-performing the communication operation regarding the legacy mode, the PD controller 491 determines whether the USB host HD2 supports a preset reconnection command (e.g., a “PD Data Reset” command) according to the CC signal and/or the management controlling signal.

When the USB host HD2 supports the preset reconnection command (i.e., the “PD Data Reset” command), it means that the PD controller 491 may directly re-perform the communication operation with the USB host HD2. The USB circuit 400C proceeds with step S660.

In step S660, based on the “PD Data Reset” command, the PD controller 491 re-performs the communication operation with the PD controller in the USB host HD2 to enter the second mode (i.e., the legacy mode). In this way, the USB circuit 400C and the USB host HD2 complete the setting of the operating mode (i.e., the legacy mode) between each other.

On the other hand, when the USB host HD2 does not support the preset reconnection command (i.e., the “PD Data Reset” command), it means that the PD controller 491 may not directly re-perform the communication operation with the USB host HD2. The USB circuit 400C proceeds with steps S651 to S655.

In steps S651 to S655, when the routing circuit 460 switches from being connected to the first mode integrating circuit 470 to being connected to the second mode integrating circuit 480, the PD controller 491 executes multiple reconnection commands, so that the upstream port interface circuit 430 re-establishes a connection relationship with the USB host HD2 according to the reconnection commands, and then enters the second mode (i.e., the legacy mode). In this way, in the legacy mode, the second mode integrating circuit 480 transmits the data from the USB host HD2 according to the re-established connection relationship.

Specifically, in steps S651 to S652, based on the reconnection commands (e.g., a “USB-C Error Recovery” command and an “Enable Legacy Term” command) sequentially, the PD controller 491 re-performs the communication operation with the PD controller in the USB host HD2.

In step S653, during the process of re-performing the communication operation, the PD controller 491 determines whether the legacy mode in the USB host HD2 complies with the USB3 specification according to the CC signal and/or the management controlling signal.

When the legacy mode of the USB host HD2 complies with the USB3 specification, it means that the PD controller 491 and the USB host HD2 may directly set the legacy mode that complies with the USB3 specification based on a preset transmission speed. In this way, the USB circuit 400C and the USB host HD2 complete the setting of the operating mode between each other (i.e., the legacy mode).

On the other hand, when the legacy mode of the USB host HD2 does not comply with the USB3 specification, it means that the PD controller 491 and the USB host HD2 may not directly set the legacy mode that complies with the USB3 specification based on the preset transmission speed. That is to say, the controlling circuit 450 determines that connection state indicates that the USB circuit 400C and the USB host HD2 may not establish the preset legacy mode according to the communication operation. The USB circuit 400C proceeds with steps S654 to S655.

That is to say, when the connection state indicates that the operation of the second mode (i.e., the legacy mode) corresponding to the second mode integrating circuit 480 fails, it means that the legacy mode may not be established between the USB circuit 400C and the USB host HD2 based on the USB3 specification, or the legacy mode of the USB host HD2 does not support the USB3 specification. At this time, the controlling circuit 450 connects the routing circuit 460 to the second mode integrating circuit 480 based on the connection protocols 481 to 485 sequentially according to the connection state and multiple transmission speeds in step S653.

In steps S654 to S655, based on the reconnection commands (e.g., a “PD Hard Reset” command and the “Enable Legacy Term” command) sequentially, the PD controller 491 re-performs the communication operation with the PD controller in the USB host HD2. First, the PD controller 491 and the USB host HD2 set the legacy mode that complies with the USB3 specification based on the fastest connection protocol 484. Assuming that the connection state indicates that the operation of the legacy mode corresponding to the connection protocol 484 fails, the PD controller 491 and the USB host HD2 set the legacy mode based on the next fastest connection protocol 483, and the rest may be derived by analogy until the USB circuit 400C and the USB host HD2 complete the setting of the legacy mode that complies with the USB2 or USB3 specifications between each other.

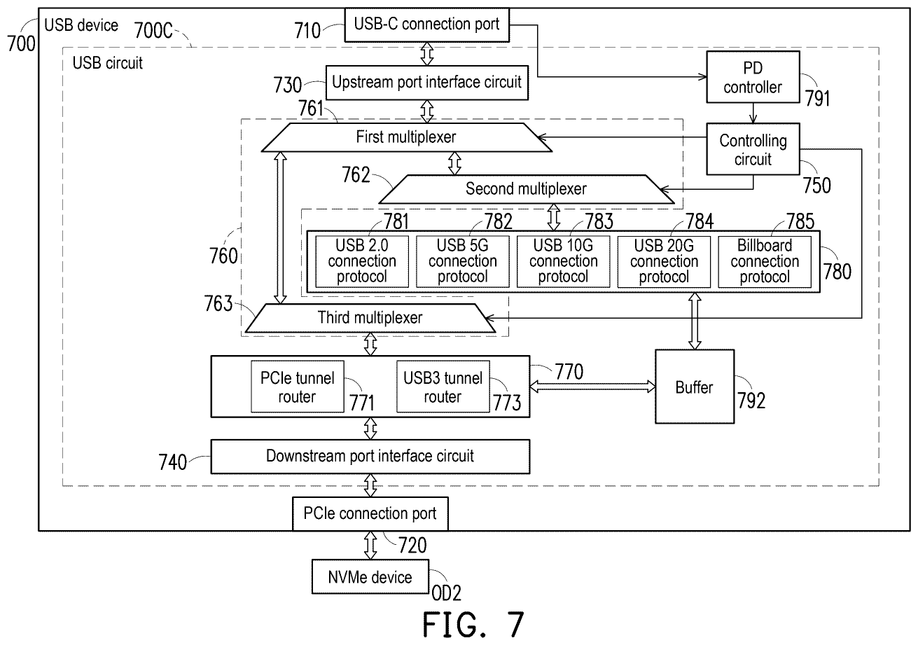

FIG. 7 is a circuit block diagram of a USB device and a USB circuit according to another embodiment of the disclosure. Referring to FIG. 7, a USB device 700 is configured to be connected to a USB host (e.g., the USB host HD2 in FIG. 4). The USB device 700 includes an upstream connection port 710, a downstream connection port 720, and a USB circuit 700C. The USB circuit 700C includes an upstream port interface circuit 730, a downstream port interface circuit 740, a controlling circuit 750, a routing circuit 760, a first mode integrating circuit 770, a second mode integrating circuit 780, a PD controller 791, and a buffer 792. The USB device 700 and the USB circuit 700C may refer to relevant descriptions of the USB device 400 and the USB circuit 400C, and may be derived by analogy.

In the embodiment of FIG. 7, the USB device 700 may be used as an interface conversion device for USB4 to PCIe. The USB device 700 is connected to the USB host through the upstream port interface circuit 730 and the upstream connection port 710. The upstream connection port 710 may be, for example, a connection port using USB-C.

In addition, the USB device 700 is connected to an output device OD2 through the downstream port interface circuit 740 and the downstream connection port 720. The downstream connection port 720 may be, for example, a connection port using PCIe. The output device OD2 may be, for example, a solid-state disk (SSD) device using a non-volatile memory express (NVMe) protocol.

In an application of the PCIe interface conversion device, the USB device 700 transmits the data between the USB host and the output device OD2 through one of a PCIe tunnel router 771 and a USB3 tunnel router 773.

It should be noted that compared to the embodiment of FIG. 4, since the data using a PCIe specification is not required to be pre-processed before being transmitted, in the application of the PCIe interface conversion device, the DP tunnel router may be removed from the first mode integrating circuit 770. In addition, the buffer may also be removed from the USB circuit 700C.

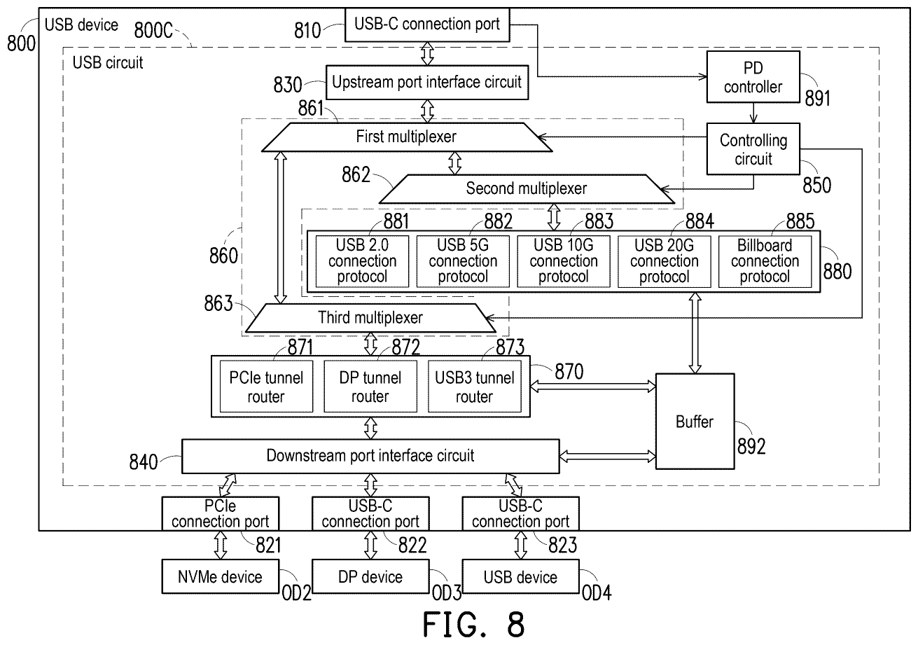

FIG. 8 is a circuit block diagram of a USB device and a USB circuit according to another embodiment of the disclosure. Referring to FIG. 8, a USB device 800 is configured to be connected to a USB host. The USB device 800 includes an upstream connection port 810, multiple downstream connection ports 821 to 823, and a USB circuit 800C. The USB circuit 800C includes an upstream port interface circuit 830, a downstream port interface circuit 840, a controlling circuit 850, a routing circuit 860, a first mode integrating circuit 870, a second mode integrating circuit 880, a PD controller 891, and a buffer 892. The USB device 800 and the USB circuit 800C may refer to the relevant descriptions of the USB device 400 and the USB circuit 400C, and may be derived by analogy.

In the embodiment of FIG. 8, the USB device 800 may be used as an interface conversion device for USB4 to PCIe, DP, and USB. The USB device 800 is connected to the USB host (e.g., the USB host HD2 in FIG. 4) through the upstream port interface circuit 830 and the upstream connection port 810. The upstream connection port 810 may be, for example, a connection port using USB-C.

In this embodiment, the USB device 800 is connected to the output device OD2 through the downstream port interface circuit 840 and the downstream connection port 821. The downstream connection port (i.e., the PCIe connection port) 821 and the connected output device (i.e., a NVMe device) OD2 may refer to relevant descriptions of the downstream connection port 720 and the output device OD2, and may be derived by analogy.

In addition, the USB device 800 is further connected to an output device OD3 through the downstream port interface circuit 840 and the downstream connection port 822. The downstream connection port 822 may be, for example, a connection port using DP. The output device OD3 may be, for example, a DP device using a DP specification, such as a display.

In an application of the DP interface conversion device, the USB device 800 transmits the data between the USB host and the output device OD3 through one of a DP tunnel router 872 and the second mode integrating circuit 880. The content of the aforementioned data is data that complies with a DP format.

In addition, the USB device 800 is further connected to an output device OD4 through the downstream port interface circuit 840 and the downstream connection port 823. The downstream connection port 822 may be, for example, a connection port using USB-C. The output device OD3 may be, for example, a USB device or a USB hub using the USB4 specification.

In an application of the USB interface conversion device, the USB device 800 transmits the data between the USB host and the output device OD4 through one of a USB3 tunnel router 873 and the second mode integrating circuit 880. The content of the aforementioned data is data that complies with a USB format.

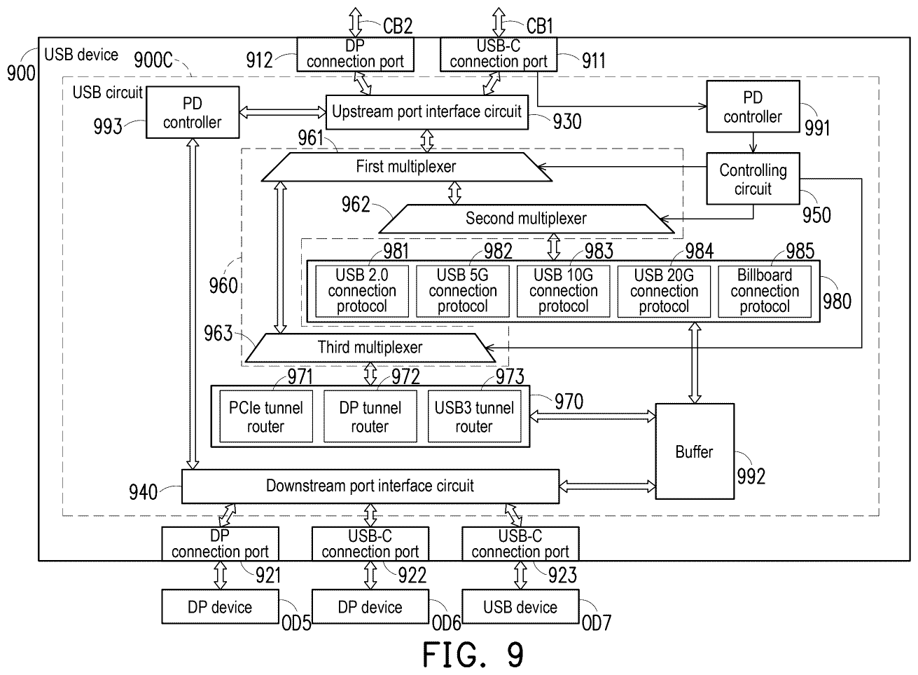

FIG. 9 is a circuit block diagram of a USB device and a USB circuit according to another embodiment of the disclosure. Referring to FIG. 9, a USB device 900 is configured to be connected to multiple USB hosts. The USB device 900 includes multiple upstream connection ports 911 to 912, multiple downstream connection ports 921 to 923, and a USB circuit 900C. The USB circuit 900C includes an upstream port interface circuit 930, a downstream port interface circuit 940, a controlling circuit 950, a routing circuit 960, a first mode integrating circuit 970, a second mode integrating circuit 980, a PD controller 991, and a buffer 992. The USB device 900 and the USB circuit 900C may refer to the relevant descriptions of the USB device 400 and the USB circuit 400C, and may be derived by analogy.

In the embodiment of FIG. 9, the USB device 900 may be used as a USB4 interface conversion device. The USB device 900 is connected to the USB host (e.g., the USB host HD2 in FIG. 4) through the upstream port interface circuit 930, the upstream connection port 911, and the USB-C cable CB1. The upstream connection port 911 may be, for example, a connection port using USB-C. The USB device 900 is further connected to an image source host (e.g., a display card) through the upstream port interface circuit 930, the upstream connection port 912, and a DP cable CB2. The upstream connection port 912 may be, for example, a connection port using DP.

In this embodiment, the USB device 900 is connected to an output device OD7 through the downstream port interface circuit 940 and the downstream connection port 923. The downstream connection port 923 may be, for example, a connection port using USB-C. The output device OD7 may be, for example, a USB device or a USB hub using the USB4 specification. The downstream connection port (i.e., a USB-C connection port) 923 and the connected output device (i.e., the USB device) OD7 may refer to relevant descriptions of the downstream connection port 823 and the output device OD4, and may be derived by analogy.

In this embodiment, the USB device 900 is further connected to an output device OD5 through the downstream port interface circuit 940 and the downstream connection port 921. The downstream connection port 921 may be, for example, a connection port using DP. The output device OD5 may be, for example, a DP device using the DP specification, such as the display.

In addition, the USB device 900 is further connected to the output device OD6 through the downstream port interface circuit 940 and the downstream connection port 922. The downstream connection port 922 may be, for example, a connection port using USB-C. The output device OD6 may be, for example, another DP device having the USB-C connection port and using the DP specification, such as another display.

It should be noted that the USB circuit 900C further includes a retimer 993. The retimer 993 may be, for example, a DP retimer configured to process the DP data to maintain connection quality of the DP interface, and configured to implement a DP Alt mode. The retimer 993 is connected to the upstream port interface circuit 930 and the downstream port interface circuit 940.

In the application of the DP interface conversion device, the USB device 900 transmits the data between the USB host and/or the image source host and the output devices OD5 to OD6 through at least one of a DP tunnel router 972, a USB3 tunnel router 973, and the second mode integrating circuit 980. The content of the aforementioned data is the data that complies with the DP format. In this way, the USB device 900 may achieve functions of using multiple displays at the same time.

In the DP Alt mode, the aforementioned data may be transmitted between the upstream port interface circuit 930 and the downstream port interface circuit 940 through the retimer 993 without using the DP tunnel router 972 to package the tunnel data that complies with the USB4 specification.

Based on the above, the USB circuit and the operating method thereof, and the USB device according to the embodiments of the disclosure may achieve conversion functions of various interfaces and transforming functions of various transmission speeds. By operating the firmware of the USB circuit according to the connection state between the USB circuit and the USB host, the USB device may dynamically switch between tunnel mode and the legacy mode. In some embodiments, through the USB circuit sequentially setting the legacy mode based on different connection protocols, the USB device may adaptively adjust the protocol between the USB circuit and the USB host. In this way, the USB device may be connected to various versions of the USB hosts, and the connected output devices may be successfully enumerated, so as to eliminate connection abnormality.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A universal serial bus (USB) circuit, comprising:
an upstream port interface circuit configured to be connected to a USB host;
a routing circuit connected to the upstream port interface circuit;
a first mode integrating circuit;
a second mode integrating circuit;
a downstream port interface circuit connected to at least one of the first mode integrating circuit and the second mode integrating circuit, and configured to be connected to at least one output device; and
a controlling circuit connected to the routing circuit, and configured to determine whether to connect the routing circuit to the first mode integrating circuit or the second mode integrating circuit according to a connection state between the USB circuit and the USB host.

2. The USB circuit according to claim 1, wherein when the connection state indicates that an operation of a first mode corresponding to the first mode integrating circuit fails, the controlling circuit switches the routing circuit from being connected to the first mode integrating circuit to being connected to the second mode integrating circuit according to the connection state.

3. The USB circuit according to claim 2, wherein when the routing circuit switches from being connected to the first mode integrating circuit to being connected to the second mode integrating circuit, the upstream port interface circuit re-establishes a connection relationship with the USB host according to a plurality of reconnection commands, so that the second mode integrating circuit transmits data from the USB host according to the connection relationship.

4. The USB circuit according to claim 1, wherein the first mode integrating circuit comprises a plurality of tunnel routers, wherein the tunnel routers respectively correspond to different tunnel protocols and comply with a USB4 specification.

5. The USB circuit according to claim 1, wherein the second mode integrating circuit has a plurality of connection protocols, wherein the connection protocols respectively correspond to different transmission speeds.

6. The USB circuit according to claim 5, wherein when the connection state indicates that an operation of a second mode corresponding to the second mode integrating circuit fails, the controlling circuit connects the routing circuit to the second mode integrating circuit based on the connection protocols sequentially according to the connection state and the transmission speeds.

7. The USB circuit according to claim 1, wherein the routing circuit comprises:
a first multiplexer connected to the upstream port interface circuit and the controlling circuit;
a second multiplexer connected to the controlling circuit and the second mode integrating circuit, and configured to be connected to the first multiplexer; and
a third multiplexer connected to the controlling circuit and the first mode integrating circuit, and configured to be connected to the first multiplexer.

8. The USB circuit according to claim 7, wherein the first multiplexer chooses to be connected to the second multiplexer or the third multiplexer according to a first controlling signal from the controlling circuit,
wherein the second multiplexer selects one of a plurality of connection protocols to be connected to the second mode integrating circuit according to a second controlling signal from the controlling circuit,
wherein the third multiplexer selects one of a plurality of tunnel protocols to be connected to the first mode integrating circuit according to a third controlling signal from the controlling circuit.

9. The USB circuit according to claim 1, further comprising:
a power delivery controller connected to the controlling circuit, and configured to perform a communication operation with the USB host, wherein the controlling circuit determines the connection state based on a success or a failure of the communication operation.

10. The USB circuit according to claim 1, further comprising:
a buffer connected to the first mode integrating circuit, the second mode integrating circuit, and the downstream port interface circuit.

11. The USB circuit according to claim 1, further comprising:
a retimer connected to the upstream port interface circuit and the downstream port interface circuit.

12. An operating method of a USB circuit, comprising:
connecting a USB host through an upstream port interface circuit of the USB circuit, wherein the upstream port interface circuit is further connected to a routing circuit of the USB circuit, wherein the USB circuit further comprises a downstream port interface circuit, a first mode integrating circuit, and a second mode integrating circuit; and
through a controlling circuit of the USB circuit, determining whether to connect the routing circuit to the first mode integrating circuit or the second mode integrating circuit according to a connection state between the USB circuit and the USB host.

13. A USB device, comprising:
at least one upstream connection port;
at least downstream connection port; and
a USB circuit, comprising:
an upstream port interface circuit configured to be connected to a USB host through the at least one upstream connection port;
a routing circuit connected to the upstream port interface circuit;
a first mode integrating circuit;
a second mode integrating circuit;
a downstream port interface circuit connected to at least one of the first mode integrating circuit and the second mode integrating circuit, and configured to be connected to at least one output device through the at least one downstream connection port; and
a controlling circuit connected to the routing circuit, and configured to determine whether to connect the routing circuit to the first mode integrating circuit or the second mode integrating circuit according to a connection state between the USB circuit and the USB host.
